(19) United States
(12) Patent Application Publication
(10) Pub. No.: US 2010/0237607 A1
(43) Pub. Date: Sep. 23, 2010

(54) DUAL EXHAUST SYSTEM

(76) Inventors: ADAM CRONE, Bloomsburg, PA (US); Matt J. Crone, Bloomsburg, PA (US)

Correspondence Address: LAW OFFICE OF JERRY D. HAYNES , P.A, P.O. Box 350392, Fort Lauderdale, FL, 33335, US

(21) Appl. No.: 12/406,118

(22) Filed: Mar. 18, 2009

(51) Int. Cl. F01N 7/00; F16L 39/00

(52) U.S. Cl. 285/131.1; 138/155

(57) ABSTRACT

The present invention relates to an exhaust piping system designed for a motor vehicle which includes: a first opening that includes a six inch inside diameter; a first bend downward from the first opening; a second bend downward from the first bend, wherein the pipe maintains a six inch inside diameter; a straight section downward from the second bend, wherein the pipe maintains a six inch inside diameter; a y-shaped piping attachment connected to the straight section at a first end, where the y-shaped piping splits the exhaust along two paths to the two remaining openings. A first straight exhaust pipe may be attached to the first opening and e transitions from a 6 inch outside diameter to a 7 inch outside diameter. A second straight exhaust pipe may be attached to the second opening and transitions from a 6 inch outside diameter to a 7 inch outside diameter.

### BACKGROUND OF INVENTION

1. Field of Invention

The present invention relates to a uniquely designed exhaust system to maximize performance and aesthetic appearance of a vehicle.

2. Description of Related Art

Vehicle exhaust systems provide an essential means to expel gas produced from an internal combustion engine operation. Exhaust gases from the engine may reach up to 1,000 degrees Fahrenheit when exiting the manifold and emitted into the exhaust system. One of the purposes of the exhaust system is to cool these gases as they exit the exhaust system.

One method to accommodate the cooling process involves modifying the exhaust pipe after the muffler in order to lower exhaust temperatures. Larger diameter pipes allow for lower exhaust temperatures, however many manufacturers of exhaust systems and vehicles in general provide pipes that are usually no larger than 4 inches in diameter. The smaller pipes therefore deprive the consumer of maximum exhaust output and performance. Larger diameter exhaust systems also provide a deeper tone of the vehicle during operation. Such a system may be particularly useful on a large diesel pickup truck.

### SUMMARY OF INVENTION

The present invention relates to an exhaust piping system designed for a motor vehicle comprising: a first opening that includes a six inch inside diameter; a first bend downward from the first opening; a second bend downward from the first bend, wherein the pipe maintains a six inch inside diameter; a straight section downward from the second bend, wherein the pipe maintains a six inch inside diameter; a y-shaped piping attachment connected to the straight section at a first end, where the y-shaped piping splits the exhaust along two paths to the two remaining openings, a first opening and a second opening; a first straight exhaust pipe attached to the first opening, where said first straight exhaust pipe transitions from a 6 inch outside diameter to a 7 inch outside diameter; and a second straight exhaust pipe attached to the second opening, where said second straight exhaust pipe transitions from a 6 inch outside diameter to a 7 inch outside diameter. The first bend may be a 45-degree bend and the second bend may be a 45-degree bend.

The present invention may be installed on a pick up truck or other suitable vehicle. When the exhaust piping system is installed upon a pick up truck or the like, the first straight exhaust pipe and second straight exhaust pipe extend beyond the rear bumper. The exhaust piping system according to the present invention may be manufactured from stainless steel, chrome or aluminum metal.

### BRIEF DESCRIPTION OF DRAWINGS

FIG. 1 depicts an exhaust pipe configuration according to the present invention.

FIG. 2 shows the exhaust pipe configuration according to the present invention as attached to the rear of a pickup truck.

### DETAILED DESCRIPTION

The present invention provides a large dual exhaust system particularly useful on larger pickup trucks. The exhaust system according to the present invention provides a larger diameter exhaust system that assists in lowering exhaust gas temperature and to provides overall better performance for the vehicle. The exhaust system according to the present invention also increases the aesthetic appeal of the vehicle and provides a deeper and richer tone while the vehicle is being operated.

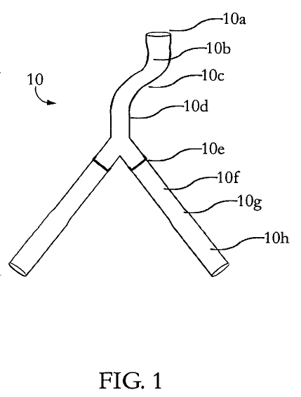

As depicted in FIG. 1, the exhaust system 10 according to the present invention is shown. In general, the exhaust piping system according to the present invention is Y-shaped dual exhaust system that provides dual exhaust exiting on both sides of a vehicle once installed. Various points are designated on the exhaust pipe system 10 within FIG. 1. These points, as noted, relate to diameter changes and curvature related to the piping system 10. Point 10a designates a 6-inch outside diameter to a 6-inch inside diameter, which is connected to the muffler system of the vehicle. Below the opening at 10a, is a first 45-degree bend 10b in the exhaust system according to the present invention. The first bend 10b extends downwardly and directly into a second 45 degree bend 10c. It is noted that the diameter throughout the two 45 degree bends is 6 inches. Continuing downward from the second 45-degree bend 10c is noted a small straight section that leads into a Y-configuration just below the portion labeled 10d. The Y-shape creates two outside openings that provide reception for two straight extending exhausts as noted in FIG. 1. The opening at 10e is a 6-inch outside diameter, which connects to the 6 inch inside diameter and creates a slip joint to receive two straight exhaust pipes. As noted each exhaust pipe is similar of this dual system 10. Initially, the straight exhaust pipe maintains a 6-inch diameter as noted at 10f. Below the beginning section of the straight exhaust 10f is a 7-inch to 6-inch reducer 10g. This reducer provides further expansion of the pipe diameter to 7 inches at the exit point of 10h.

Essentially this large pipe starts off with a 6-inch diameter and extends through the Y-portion to two straight dual exhausts, which initially start at 6 inches outside diameter and are enlarged to a 7-inch diameter at the reducer point 10g. This unique extreme super dual exhaust system is not available on market and therefore not available for the consumer. The exhaust system 10 according to the present invention provides the consumer with an alternative exhaust system to improve performance and provide for aesthetic appeal.

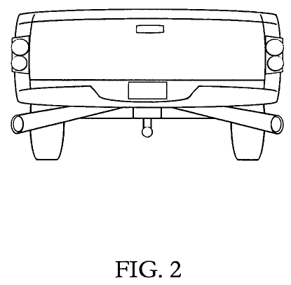

FIG. 2 shows the dual exhaust system 10 according to the present invention as installed upon a pickup truck. A rearview of the pickup truck is shown where each exhaust pipe is noted to be exiting under the rear bumper of the pickup truck. Since these exhaust pipes are shaped in a Y-shape, the exhausts extend outwardly at an angle and provide an appealing view of the truck's exhaust system. The dual exhausts exit the underside of the vehicle just behind the rear axle.

This exhaust system according to the present invention consequently helps to reduce exhaust temperatures tremendously. It also provides consumers with an opportunity to customize their exhaust system tubing and gives them an option greater than 4 inches in diameter. The large diameter advantageously provides greater tone and sound resonance associated with the vehicle. The exhaust system according to the present invention may be made of chrome, stainless steel or aluminum metal.

What is claimed is:

1. An exhaust piping system designed for a motor vehicle comprising:
a. a first opening includes a six inch inside diameter;
b. a first bend downward from the first opening;
c. a second bend downward from the first bend, wherein the pipe maintains a six inch inside diameter;
d. a straight section downward from the second bend, wherein the pipe maintains a six inch inside diameter;
e. a y-shaped piping attachment connected to the straight section at a first end, where the y-shaped piping splits the exhaust along two paths to the two remaining openings, a first opening and a second opening;
f a first straight exhaust pipe attached to the first opening, where said first straight exhaust pipe transitions from a 6 inch outside diameter to a 7 inch outside diameter; and
g. a second straight exhaust pipe attached to the second opening, where said second straight exhaust pipe transitions from a 6 inch outside diameter to a 7 inch outside diameter.

2. The exhaust piping system according to claim 1 wherein the first bend is a 45 degree bend and the second bend is a 45 degree bend.

3. The exhaust piping system according to claim 1, where the motor vehicle is a pick up truck.

4. The exhaust piping system according to claim 3, where the first straight exhaust pipe and second straight exhaust pipe extend beyond the rear bumper when installed on the pick up truck.

5. The exhaust piping system according to claim 1, where the piping system is manufactured from at least one of stainless steel, chrome and aluminum metal.

6. The exhaust piping system according to claim 1, where a reducer provides for the transition within the first straight exhaust pipe and the second straight exhaust pipe.

7. The exhaust piping system according to claim 1, where the first bend and second bend create a s-pipe.

8. The exhaust piping system according to claim 1, where the y-shaped pipe is eight inches long along the two paths to the two remaining openings.

9. The exhaust piping system according to claim 8, where the last three inches of the eight-inch length is expands from a six inch outside diameter to a six inch inside diameter.

10. The exhaust piping system according to claim 1, where the first straight exhaust pipe and second straight exhaust pipe include two foot long seven inch diameter exhaust openings.
